(19) United States
(12) Patent Application Publication
(10) Pub. No.: US 2026/0269753 A1
(43) Pub. Date: Sep. 10, 2026

(54) PMSM FLUX WEAKENING FOR APPLIANCE MOTORS

(71) Applicant: Haier US Appliance Solutions, Inc., Wilmington, DE (US)

(72) Inventor: Joseph Wilson Latham, Louisville, KY (US)

(21) Appl. No.: 19/070,692

(22) Filed: Mar. 5, 2025

(51) Int. Cl. H02P 21/00; D06F 37/30; H02P 21/18

(52) U.S. Cl. CPC H02P 21/0089; D06F 37/304; H02P 21/18; H02P 2207/05

(57) ABSTRACT

A method for controlling a motor of a domestic appliance is provided. The method includes receiving, via a controller, a d-axis current error signal and a q-axis current error signal. The method also includes determining, via the controller, a d-axis voltage component signal based, at least in part, on the q-axis current error signal. The d-axis voltage component signal is limited by a first voltage threshold. Further, the method includes then determining, via the controller, a q-axis voltage component signal based, at least in part, on the d-axis current error signal. The q-axis voltage component signal is limited by a second voltage threshold that is less than the first voltage threshold. In addition, the method includes controlling, via the controller, the motor using a field-oriented control scheme based, at least in part, on the d-axis voltage component signal and the q-axis voltage component signal.

### FIELD OF THE INVENTION

The present disclosure relates to an electric motor, and more particularly to a system and method of controlling a permanent magnet synchronous motor (PMSM).

### BACKGROUND OF THE INVENTION

Motors are used in various appliances to convert electrical power into mechanical energy to produce actuation about an axis. For example, in a washing machine a motor can be coupled with a washing tub such that the tub rotates at various speeds. In an air conditioner, a motor can be coupled with a fan to circulate air. In a refrigerator, a motor can be coupled with a compressor to supply cool air into a fresh food and/or freezer compartment.

A permanent magnet synchronous motor (PMSM) can include a rotor having a permanent magnet and a stator having a plurality of electromagnetic poles such that the rotor rotates about an axis by locking into the rotating magnetic fields generated on the stator. In a PMSM, base speed is the maximum speed the motor can reach without modifying the magnetic field between a rotor and stator of the motor. If speeds above the base speed are desired, the motor can be controlled using flux weakening techniques. Flux weakening can reduce the magnitude of the magnetic field (magnetic flux) between the rotor and the stator, thereby reducing torque and increasing the speed of the motor above the base speed without causing damage to the motor.

Traditionally, field-oriented control (FOC) can be used to control a motor. In FOC systems, the voltage applied to the stator poles is adjusted to achieve the desired speed. However, voltage capabilities of a motor drive pose a constraint to achieving high speeds because higher speeds require more voltage. Hence, at a certain speed, an operating phase voltage will reach a maximum phase voltage of the motor drive, and the speed of the motor will no longer be able to be increased. To allow the motor to be driven at higher rates of speed than the voltage capabilities of the motor drive would otherwise allow, a flux weakening operation may be implemented by adding negative d-axis current. However, due to cross-axes dependency of dq voltage signals and dq current signals, excessive or insufficient negative d-axis current may be added by the flux weakening operation, which may reduce the efficiency of the motor and/or cause voltage ripple to propagate into the motor torque.

Thus, a control technique of a PMSM motor that can implement dynamic flux weakening to achieve a desired speed and thereby maximize the efficiency of the motor would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method for controlling a motor of a domestic appliance is provided. The method includes receiving, via a controller, a d-axis current error signal and a q-axis current error signal. The method also includes determining, via the controller, a d-axis voltage component signal based, at least in part, on the q-axis current error signal. The d-axis voltage component signal is limited by a first voltage threshold. Further, the method includes then determining, via the controller, a q-axis voltage component signal based, at least in part, on the d-axis current error signal. The q-axis voltage component signal is limited by a second voltage threshold that is less than the first voltage threshold. In addition, the method includes controlling, via the controller, the motor using a field-oriented control scheme based, at least in part, on the d-axis voltage component signal and the q-axis voltage component signal.

In one exemplary aspect of the present disclosure, a motor system is provided. The motor system includes a motor having a rotor and a stator. The motor system also includes a controller configured to control the motor. The controller is configured to perform operations for controlling the motor. The operations include receiving a d-axis current error signal and a q-axis current error signal. The operations also include determining a d-axis voltage component signal based, at least in part, on the q-axis current error signal. The d-axis voltage component signal is limited by a first voltage threshold. Further, the operations include then determining a q-axis voltage component signal based, at least in part, on the d-axis current error signal. The q-axis voltage component signal is limited by a second voltage threshold that is less than the first voltage threshold. In addition, the operations include controlling the motor using a field-oriented control scheme based, at least in part, on the d-axis voltage component signal and the q-axis voltage component signal.

In one exemplary aspect of the present disclosure, a motorized appliance is provided. The motorized appliance includes at least one motorized component. The motorized appliance also includes a motor system configured to drive the at least one motorized component. The motor system includes a motor having a rotor and a stator. The motor system also includes a controller configured to control the motor. The controller is configured to perform operations for controlling the motor. The operations include receiving a d-axis current error signal and a q-axis current error signal. The operations also include determining a d-axis voltage component signal based, at least in part, on the q-axis current error signal. The d-axis voltage component signal is limited by a first voltage threshold. Further, the operations include then determining a q-axis voltage component signal based, at least in part, on the d-axis current error signal. The q-axis voltage component signal is limited by a second voltage threshold that is less than the first voltage threshold. In addition, the operations include controlling the motor using a field-oriented control scheme based, at least in part, on the d-axis voltage component signal and the q-axis voltage component signal.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary domestic appliance, e.g., an exemplary washing machine appliance, according to one or more additional example embodiments of the present disclosure.

FIG. 2 provides a cross-sectional view of the example washing machine of FIG. 1.

FIG. 3 provides a schematic diagram of an example permanent magnet synchronous motor.

FIG. 4 provides a block diagram of an example implementation of a motor assembly operating in a field-oriented control (FOC) scheme according to example embodiments of the present disclosure.

FIG. 5A provides a control diagram of an example embodiment of a d-axis voltage calculation module of a current controller (e.g., from the motor assembly of FIG. 4) according to one or more example embodiments of the present disclosure.

FIG. 5B provides a control diagram of an example embodiment of a q-axis voltage calculation module of the current controller (e.g., from the motor assembly of FIG. 4) according to one or more example embodiments of the present disclosure.

FIG. 6 a flow chart diagrammatically illustrating a method of controlling a motor for a domestic appliance according to one or more additional example embodiments of the present disclosure.

FIG. 7 illustrates correlated plots of testing results of a FOC scheme using a current controller according to one or more additional example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure relate generally to a motor for a domestic appliance. For instance, example aspects of the present disclosure relate to methods and systems for controlling the motor by decoupling current control so as to implement dynamic flux weakening operations in a field-oriented control (FOC) scheme.

According to example aspects of the present disclosure, the motor can be a synchronous-type motor with a three-phase motor drive operating in a sensorless FOC scheme. Furthermore, the FOC scheme can include a sensorless feedback system configured to obtain feedback measurements of electrical characteristics (e.g., voltage, current, etc.) from the motor. In some instances, the sensorless feedback system can utilize a back electromotive (EMF) observer (e.g., counter-EMF observer) to obtain data indicative of a position or a speed of the motor.

Various domestic appliances may include a motor for performing a variety of different tasks. As such, the motor requires a robust motor drive which is capable of both low speed, high torque operation and high speed, low torque operation. However, the speed at which the motor can be driven is limited by the voltage that can be applied by the inverter and the voltage required by the motor which is primarily determined by the back-EMF of the motor. More particularly, to drive the motor, the inverter must overcome the back-EMF of the motor, and the back-EMF of the motor is proportional to the speed of the motor. Hence, at a certain speed, the inverter will not be able to provide increased voltage and will not be able to accelerate the motor any further.

As such, flux weakening operations may be implemented by adding negative d-axis current in order to reduce the back-EMF of the motor, which reduces an operating voltage of the motor and thereby permits the motor to achieve higher operating speeds than the voltage capabilities of the inverter would otherwise allow. However, adding negative d-axis current to achieve flux weakening operations requires accounting for ripple in the voltage provided by the inverter. When excessive negative d-axis current is added, the efficiency of the motor is reduced because the torque per amp output of the motor is decreased. When insufficient negative d-axis current is added, the ripple in the voltage may be propagated into the torque output by the motor.

The systems and methods according to example aspects of the present disclosure provide a number of technical effects and benefits. For instance, example aspects of the present disclosure provide a system and method for implementing a dynamic flux weakening operation. This is achieved by decoupling current control of the motor, as will be discussed in more detail below. In this way, d-axis and q-axis voltage component signals can be determined sequentially, which allows for sequential application of voltage limits. Limiting the d-axis voltage component signal prior to the q-axis voltage component signal allows the motor to draw sufficient voltage to achieve a torque specified for an application while preventing the voltage ripple from propagating into the torque. Further, the q-axis voltage component signal is then limited by the voltage remaining after generation of the d-axis voltage component signal. As such, the q-axis voltage component signal is minimized and dynamically adjusts based on the remaining voltage, which results in implementation of the dynamic flux weakening operation.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

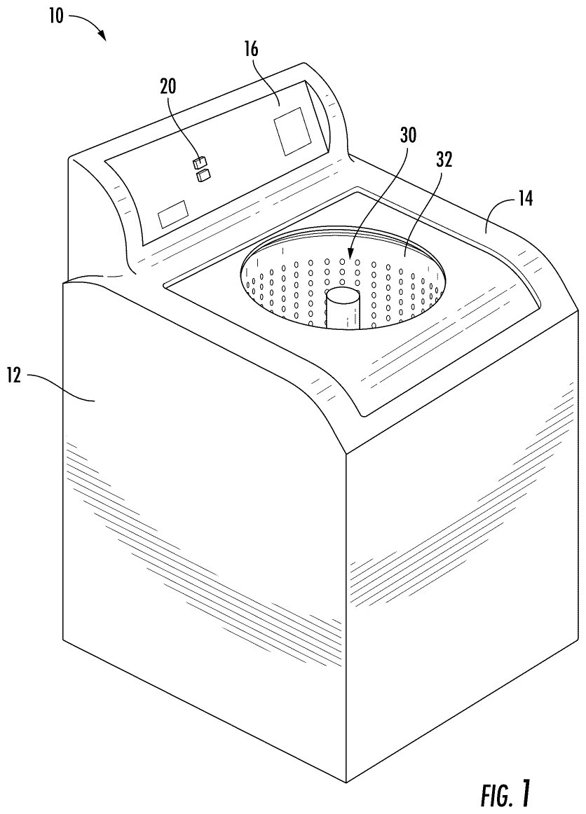

FIG. 1 provides an exemplary domestic appliance, e.g., a washing machine appliance 10, according to one or more exemplary embodiments of the present disclosure. However, it should be appreciated that the washing machine appliance 10 is provided by way of example only, and aspects of the present subject matter may be used in any suitable domestic appliance having an electric motor, such as a refrigerator appliance, an air conditioner appliance, a dishwasher appliance, a dryer appliance, etc.

The washing machine appliance 10 includes a cabinet 12 having a control panel or user interface 16 that extends from a top 14. The user interface 16 includes a variety of appliance control input selectors 20 that can be for operator selection and display of washing cycles, features, machine status, and any other information of interest to users.

The user interface 16 can have various configurations, and controls can be mounted in other configurations and locations other than as shown in FIG. 1. One or more of a variety of electrical, mechanical, or electro-mechanical input devices including rotary dials, push buttons, and touch pads can also be used singularly or in combination with other types of input devices such as a touch screen or liquid crystal display. The user interface 16 can include a display component, such as a digital or analog display device designed to provide operational feedback to a user.

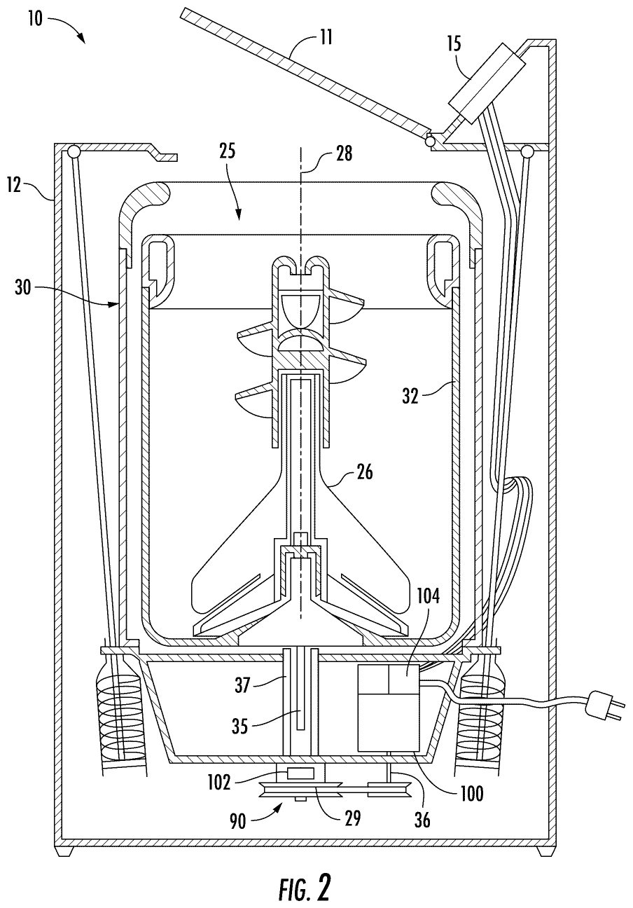

As shown in FIG. 2, the washing machine appliance 10 can include a wash chamber 30 located within cabinet 12, and a wash basket or tub 32 may be rotatably mounted within the wash chamber 30 in a spaced apart relationship from the wash chamber 30 about a vertical axis 28. The basket 32 can include a plurality of perforations therein to facilitate fluid communication between the interior of the basket 32 and the chamber 30. Articles to be washed can be loaded into the basket 32 through a door 11 and an opening 25. An agitator, impeller, or oscillatory basket mechanism 26 can be disposed in the basket 32 to impart an oscillatory motion to articles and liquid in the basket 32. The wash chamber 30 can also be in fluid communication with one or more pumps and/or drains (not shown) for the removal of water, such as grey water, from the chamber 30 such as e.g., after a wash or rinse cycle.

The washing machine appliance 10 can be controlled by a processing device or other controller 15, such as a microprocessor, according to user preference via manipulation of the control input selectors 20 that can be mounted in the user interface 16. The controller 15 and a motor controller 104 can include a memory and one or more microprocessors, microcontrollers, application-specific integrated circuits (ASICS), CPUs or the like, such as general or special purpose microprocessors operable to execute programming instructions or micro-control code associated with washing machine control, and the controller 15 is no restricted necessarily to a single element. For example, the washing machine appliance 10 can include the controller 15 and a motor controller 104, as shown in FIG. 2, for operation of the washing machine appliance 10. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, the controller 15 may be constructed without using a microprocessor, e.g., using a combination of discrete analog or digital logic circuitry (such as switches, amplifiers, integrators, comparators, flip-flops, AND gates, and the like) to perform control functionality instead of relying upon software. The controller 15 and/or the motor controller 104 can be programmed to operate washing machine appliance 10 according to the exemplary aspects of the present invention as set forth below.

As illustrated in FIGS. 1 and 2, the agitator 26 can be oriented to rotate about the vertical axis 28. However, the wash basket 32 can be oriented to rotate around any axis, such as the vertical axis 28, horizontal axis or a varying degree axis.

A motor 100 can provide for the movement of the agitator 26 via drive arrangement 40. The drive arrangement 40 can include a pulley mounted to a motor driveshaft 36 connected by a belt 29 to a pulley mechanically coupled to a basket driveshaft 35 and a spin tube 37, which can be concentric shafts. The motor driveshaft 36 can be directly coupled to the pulley and the belt 29 that drives the agitator 26. Alternatively, the washing machine appliance 10 can include any type of driving means such as a direct drive type having no belt or pulley. The spin tube 37 can be directly coupled to the basket 32 or it can be integral with the basket 32.

A clutch (not shown) can lock the basket driveshaft 35 and the spin tube 37 when the motor 100 is energized. A speed sensor 102 can be provided on the motor driveshaft 36 and can be coupled with the controller 15 and/or the motor controller 104. While illustrated below the basket driveshaft 35, the speed sensor 102 can be located in various locations in the cabinet 12 and can be used to measure the speed of various components such as the basket driveshaft 35, the motor driveshaft 36 and/or the basket 32. A plurality of speed sensors 102 can also be used.

The motor 100 may be a permanent magnet synchronous motor (PMSM) with a three-phase motor drive. PMSMs may be driven by field-oriented control (FOC), which provides for efficient and high-fidelity control. In FOC, a stator magnetic field is generated via a stator current provided through one or more stator windings at the stator. The stator field is oriented at a fixed angular offset ahead of a rotor magnetic field at the rotor. For instance, the rotor field may be produced by one or more permanent magnets or other permanent magnetic poles at the rotor. The angular offset between the rotor field and the stator field induces rotational motion at the rotor as the rotor field is made to be aligned with the stator field. By continually moving the stator field (e.g., per phases of the stator current), the rotor is made to synchronously rotate with the stator field.

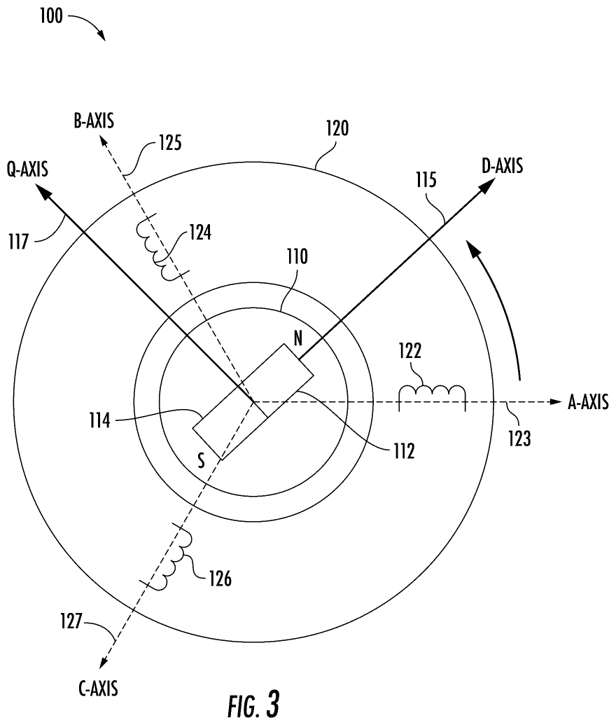

This is explained with reference to FIG. 3. FIG. 3 illustrates a schematic diagram of an example permanent magnet synchronous motor 100 according to one or more exemplary embodiments of the present disclosure. As illustrated, the motor 100 includes a rotor 110 and a stator 120. The rotor 110 includes a north magnetic pole 112 and a south magnetic pole 114. It should be understood that the rotor 110 is discussed with reference to a single north magnetic pole 112 and a single south magnetic pole 114 for the purposes of illustration. The rotor 110 can include any suitable (e.g., balanced) number of north and south magnetic poles 112, 114. An angle of the rotor magnetic field, represented by θₑ, is related to a mechanical angle of the rotor, represented by θₘ, by a number of rotor poles P. In particular, the angles are related by the equation:

$${θ}_{e} = \frac{P}{2} {θ}_{m} .$$

In addition, the (mechanical) rotor speed, represented by

$${ω}_{m} = \frac{d {θ}_{m}}{dt} ,$$

can be related to the electrical rotor speed, represented by represented by

$${ω}_{e} = \frac{d {θ}_{e}}{dt} ,$$

by the equation:

$${ω}_{e} = \frac{P}{2} {ω}_{m} .$$

In operating the motor 100, three-phase power (e.g., current/voltage signals) can be provided at each of a plurality of stator windings 122, 124, and 126. For instance, the stator winding 122 can be positioned along an a-axis 123. The stator winding 124 can be positioned along a b-axis 125 and can receive a power signal that is 120 degrees out of phase with the signal of the stator winding 122. Additionally, the stator winding 126 can be positioned along a c-axis 127 and can receive a power signal that is −120 degrees or 240 degrees out of phase with the stator winding 122.

A convenient way to represent the behavior of the motor 100 is to treat the three-phase voltages and currents as rotating space vectors. The rotating space vectors can be broken up into cartesian components. A first component, termed the direct component or D component, can be in phase with the rotor magnetic field. This component is directed along a d-axis 115. A second component, termed the quadrature component or Q component, can be out of phase with the direct component, such as 90 degrees out of phase with the direct component. For instance, this component can be directed along a q-axis 117.

In particular, voltages and currents in the rotating-space dq reference frame can be translated from the three-phase abc reference frame by suitable transforms. For instance, one example set of transforms, the Park Transform and Clarke Transform, can be performed in cascade to convert between rotating-space and three-phase. In particular, an example Park Transform is given by:

$$[ \begin{matrix}d \\ q\end{matrix} ] = [ \begin{matrix}cos {θ}_{e} & sin {θ}_{e} \\ - sin {θ}_{e} & cos {θ}_{e}\end{matrix} ] [ \begin{matrix}α \\ β\end{matrix} ]$$

and an example Clarke Transform is given by:

$$[ \begin{matrix}α \\ β\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}}\end{matrix} ] [ \begin{matrix}a \\ b \\ c\end{matrix} ]$$

Note that alternate versions of the above transformations exist, accounting for variations in the location of a zero reference angle, whether the transformation preserves amplitude or power, etc.

In the dq frame, the electrical dynamics of the stator windings can be given by:

$$[ \begin{matrix}{v}_{d} \\ {v}_{q}\end{matrix} ] = [ \begin{matrix}{R}_{s} & - {ω}_{e} {L}_{q} \\ {ω}_{e} {L}_{d} & {R}_{s}\end{matrix} ] [ \begin{matrix}{I}_{d} \\ {I}_{q}\end{matrix} ] + [ \begin{matrix}0 \\ {λ}_{m} {ω}_{e}\end{matrix} ]$$

where Rₛ is the resistance of the stator windings; L_{d}, L_{q} are the d and q axis inductances of the stator windings, which may differ from each other based on the rotor construction; and λₘ is the magnitude of the rotor magnetic flux linkage, which can be constant for a sinusoidal motor. The voltage term λₘωₑ is known as the back electromotive force (EMF) (or counter-electromotive force), and, as can be seen in the above equation, has magnitude proportional to the rotor electrical speed ωₑ.

The motor 100 can be operated according to an operation cycle. Generally, the operation cycle can represent an operation plan of the motor over at least a period of time (and/or indefinitely). As one example, the operation cycle can define a plurality of target speeds, such as a sequence of target speeds, at which the motor is to be operated. The operation cycle may be implemented by speed control (e.g., matching actual speed of the motor to target speed) and/or by other suitable implementations, such as providing voltage and/or current signals relative to target voltage and/or current signals based at least in part on the operation cycle. The operation cycle can be software-based (e.g., stored in a memory of a controller of the motor) and/or hardware-based.

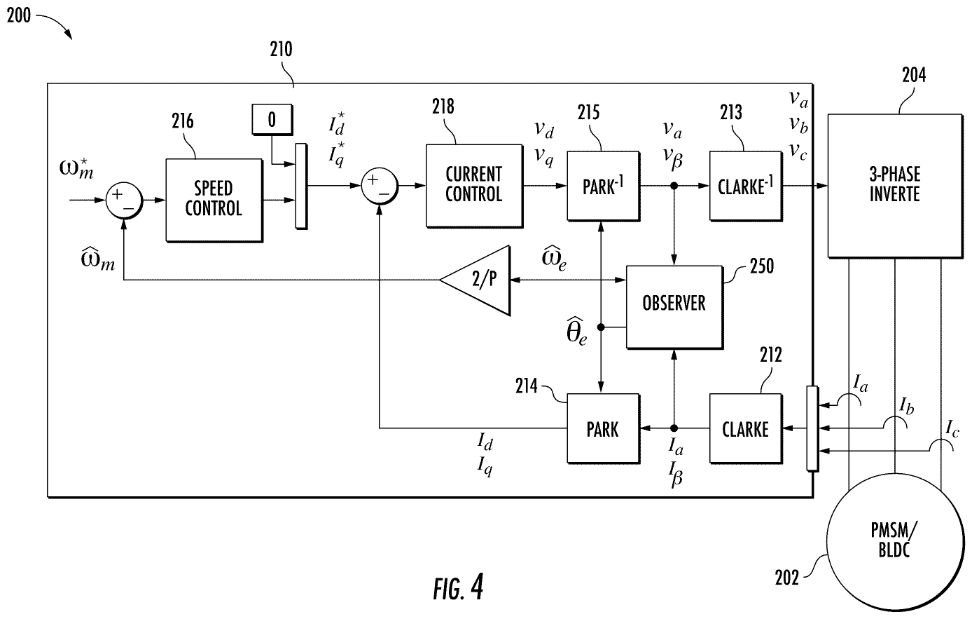

For instance, FIG. 4 illustrates a block diagram of an example implementation of a motor assembly 200 operating in a FOC scheme according to one or more exemplary embodiments of the present disclosure. As will be discussed in greater detail below, the FOC scheme can be configured to convert a three-phase signal (e.g., current/voltage) associated with the motor drive (e.g., three-phase inverter 204) into a two-phase signal. The motor assembly 200 can include a motor 202, such as a permanent magnet synchronous motor (PMSM). The motor 202 can be driven by a reversible three-phase motor drive, which can include the three-phase inverter 204 and a power supply (e.g., an alternating current power supply) (not shown). Furthermore, the three-phase inverter 204 can be electrically coupled to the power supply. The motor drive (e.g., inverter 204 and the power supply) can be operably coupled to a controller 210. The inverter 204 can likewise be operably coupled to the power supply and configured to control the motor 202. For instance, inverter 204 can supply current signals to windings at motor 202 such that the motor 202 produces rotational motion. As one example, the inverter 204 can supply three-phase current signals Iₐ, I_{b}, and I_{c} to stator windings at the motor 202 in synchronous timing such that a (e.g., permanent magnet) rotor at motor 202 rotates. The inverter 204 can produce the current signals in response to a control signal from the controller 210 (e.g., current controller 218). The controller 210 can be configured to control the inverter 204 and provide a current to one or more stators of the motor 202 to induce a stator magnetic field. In this way, the controller 210 can control an orientation of the stator magnetic field.

In addition, the motor assembly 200 can include a sensorless feedback system configured to obtain feedback measurements of one or more electrical characteristics from the motor 202. For instance, the motor assembly 200 can include an observer 250 configured to implement an observer algorithm. In some embodiments, the observer 250 can be a back-EMF observer configured to process one or more feedback measurements of one or more electrical characteristics of the motor and to provide data indicative of a position or a speed of the motor 202. As used herein, a “sensorless” feedback system is operable to determine data indicative of a position and/or a speed of the motor without a position sensor or a speed sensor.

The observer 250 may implement the observer algorithm in a different reference frame than the three-phase reference frame of motor 202 and/or inverter 204. For instance, the current signals from the inverter 204 can be transformed by Clarke transform 212 and/or Park transform 214 into a rotating reference frame (e.g., an estimated rotating reference frame). For instance, the current signals can be transformed into an alpha-beta reference frame by the Clarke transform 212, and the signals from Clarke transform 212 can be used by the observer 250 to produce an estimated angle. The estimated angle can be used in Park transform 214 to produce signals in an estimated rotating reference frame.

The observer 250 can additionally produce an estimated speed. The estimated speed can be compared to a target speed to determine a speed difference (e.g., a speed error). The speed difference can be provided to a speed controller 316 to determine a target current signal. The target current signal can be produced in the rotating reference frame. As such, the target current signal can include a q-axis target current component signal

$$( {I}_{q}^{*} )$$

and a d-axis target current component signal

$$( {I}_{d}^{*} ) .$$

In some embodiments, the speed controller 316 can determine the q-axis target current component signal

$$( {I}_{q}^{*} ) .$$

In some embodiments, the d-axis target current component signal

$$( {I}_{d}^{*} )$$

can be set to zero, as shown. In other embodiments, the d-axis target current component signal

$$( {I}_{d}^{*} )$$

can be determined by a flux weakening controller (not shown). The target current component signals

$$( {I}_{q}^{*} ) , ( {I}_{d}^{*} )$$

can be compared to the measured current component signals (I_{q}), (I_{d}) (e.g., from Park transform 214) to determine current component error signals (e.g., current component difference signals). More specifically, the q-axis target current component signal

$$( {I}_{q}^{*} )$$

can be compared to a q-axis measured current component signal to determine a q-axis current error signal (e_{iq}), and the d-axis target current component signal

$$( {I}_{d}^{*} )$$

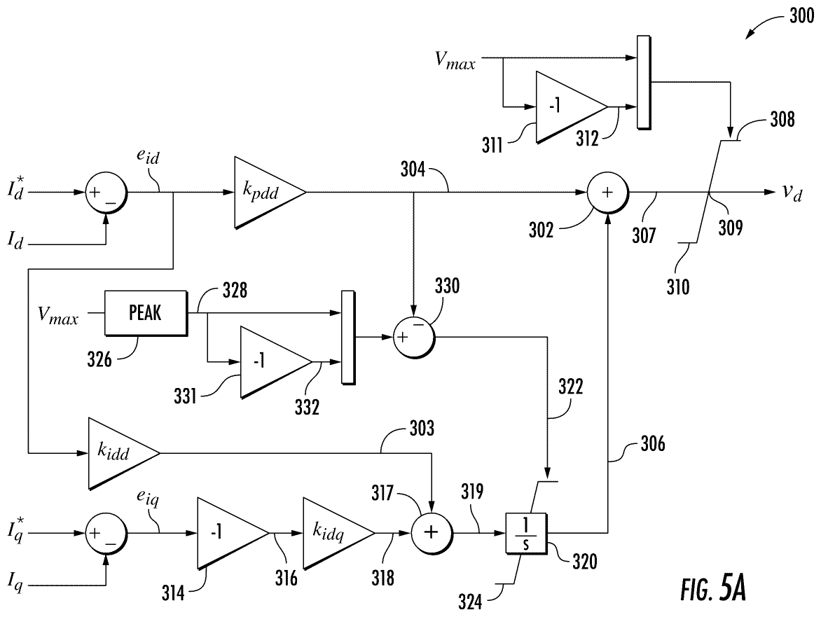

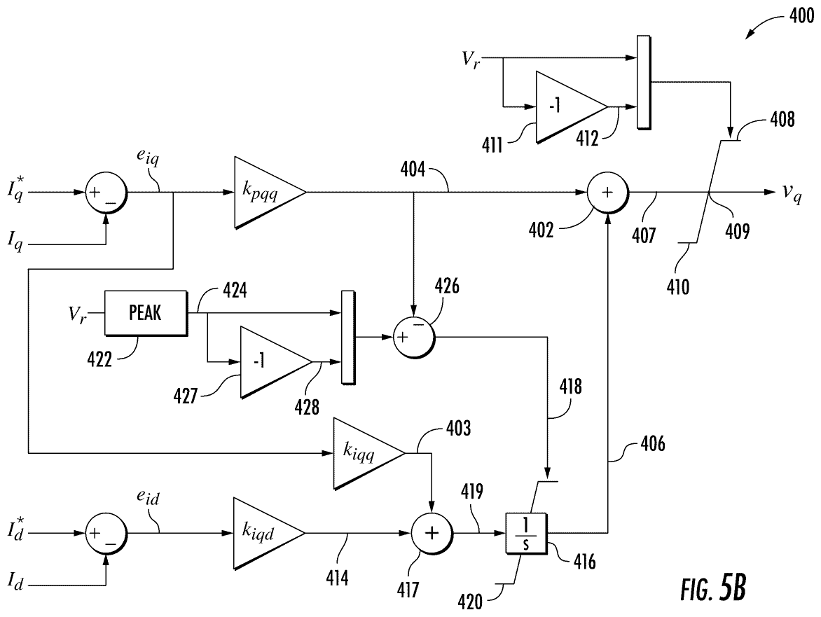

can be compared to a d-axis measured current component signal to determine a d-axis current error signal (e_{id}). The q-axis and d-axis current error signals (e_{iq}), (e_{id}) can be used by a current controller 218 to produce a control signal for the inverter 204, as described in more detail below (FIGS. 5A-5B). For instance, the control signal can be a voltage signal. The voltage signal may be in the rotating reference frame. As such, the voltage signal can include a q-axis voltage component signal (v_{q}) and a d-axis voltage component signal (v_{d}). The voltage component signals (v_{q}), (v_{d}) can be transformed (e.g., by inverse Park transform 215 and inverse Clarke transform 213) to the three-phase reference frame to be used by inverter 204.

FIGS. 5A-5B illustrate control diagrams of example voltage calculation modules 300, 400 of the current controller 218 according to one or more exemplary embodiments of the present disclosure. In particular, FIG. 5A illustrates a control diagram for a d-axis voltage calculation module 300 programmed in the current controller 218 according to the present disclosure. FIG. 5B illustrates a control diagram for a q-axis voltage calculation module 400 programmed in the current controller 218 according to the present disclosure. The current controller 218 may be configured to decouple the q-axis and d-axis current error signals (e_{iq}), (e_{id}) from the q-axis and d-axis voltage component signals (v_{q}), (v_{d}). As such, the current controller 218 may be configured to determine the d-axis and q-axis voltage component signals (v_{d}), (v_{q}) sequentially. More specifically, the current controller 218 can determine the d-axis voltage component signal (v_{d}) prior to the q-axis voltage component signal (v_{q}). That is, the current controller 218 may be configured to execute the d-axis voltage calculation module 300 prior to executing the q-axis voltage calculation module 400.

For instance, in one example implementation in accordance with one or more embodiments of the present disclosure, the design of the voltage calculation modules 300, 400 may be based on the following functional relationship(s):

$$[ \begin{matrix}{v}_{d} \\ {v}_{q}\end{matrix} ] = [ \begin{matrix}{k}_{p d d} + \frac{{k}_{idd}}{s} \frac{- {k}_{idq}}{s} \\ \frac{{k}_{iqd}}{s} {k}_{pqq} + \frac{{k}_{iqq}}{s}\end{matrix} ] [ \begin{matrix}{e}_{id} \\ {e}_{iq}\end{matrix} ]$$

where k_{pda} is a first proportional gain, k_{pqq} is a second proportional gain, s is a Laplace variable, and k_{idd}, k_{idq}, k_{iqq}, and k_{igd} are integral gains.

The integral gains k_{idd} and k_{igq} may be variable gains dependent on a speed of the motor 202. As an example, integral gains k_{idd} and k_{igg} may be inversely related to the speed of the motor 202. As such, the integral gains kidd and kiqq may decrease as the speed of the motor 202 increases. More specifically, the integral gains k_{idd} and k_{iqq} may be configured to be zero when the speed of the motor 202 is greater than or equal to a speed threshold. The speed threshold may be specified so as to be less than a base speed of the motor 202. In a PMSM motor, the base speed is the maximum speed the motor can reach without modifying the magnetic field between a rotor and stator of the motor, as mentioned above.

The integral gains k_{idq} and k_{iqd} may be variable gains dependent on the speed of the motor 202. As an example, the integral gains k_{idq} and k_{iqd} may be directly related to the speed of the motor 202. As such, the integral gains k_{idq} and k_{iqd} may increase as the speed of the motor 202 increases. More specifically, the integral gains k_{idq} and k_{iqd} may be configured to be zero when the speed of the motor 202 is zero.

As shown in FIG. 5A, the d-axis voltage calculation module 300 receives the q-axis and d-axis current error signals (e_{iq}), (e_{id}). The d-axis voltage calculation module 300 may be configured to determine the d-axis voltage component signal (v_{d}) based on the q-axis and d-axis current error signals (e_{iq}), (e_{id}). More specifically, the d-axis voltage calculation module 300 may be configured to determine the d-axis voltage component signal (Va) by combining (e.g., via a summator 302) a first signal 304 and a second signal 306 to obtain an output 307.

The d-axis voltage calculation module 300 may be further configured to constrain the output 307 via a saturator 309 to obtain the d-axis voltage component signal (v_{d}). The d-axis voltage component signal (v_{d}) can be constrained by an upper limit 308 and a lower limit 310. In some embodiments, the d-axis voltage calculation module 300 may be configured to determine the upper limit 308 and the lower limit 310. The upper limit 308 and the lower limit 310 may be determined based, at least in part, on a first voltage threshold. The first voltage threshold may be a fixed voltage. For example, the first voltage threshold may be a maximum phase voltage (Vₘₐₓ) of the motor drive (e.g., inverter 204). In some instances, the maximum phase voltage (Vₘₐₓ) can be based at least in part on a DC bus voltage of the inverter 204. As shown, the maximum phase voltage (Vₘₐₓ) can be the upper limit 308. Additionally, a gain 311 can be applied (e.g., via multiplication) to the maximum phase voltage (Vₘₐₓ) to obtain a negated maximum phase voltage 312. As such, the gain 311 may have a value of negative one (−1). The negated maximum phase voltage 312 can be the lower limit 310. When the speed of the motor 202 is greater than or equal to the base speed of the motor 202, the d-axis voltage component signal (v_{d}) can be configured to achieve the q-axis target current component signal

$$( {I}_{q}^{*} ) .$$

The d-axis voltage calculation module 300 may be configured to determine the first signal 304 based on the d-axis current error signal (e_{id}). For example, the d-axis voltage calculation module 300 may be configured to apply the first proportional gain k_{pdd} (e.g., via multiplication) to the d-axis current error signal (e_{id}) to obtain the first signal 304. The first proportional gain k_{pdd} may be a fixed gain (e.g., determined empirically based on testing and/or simulation to determine a value that maximizes control stability for the motor).

Further, the d-axis voltage calculation module 300 may be configured to determine the second signal 306 based, at least in part, on the q-axis current error signal (e_{iq}). When the speed of the motor 202 is less than the base speed of the motor, the second signal 306 may be determined based on the q-axis current error signal (e_{iq}) and the d-axis current error signal (e_{id}). For example, the d-axis voltage calculation module 300 may be configured to apply the integral gain k_{idd} (e.g., via multiplication) to the d-axis current error signal (e_{id}) to obtain a first output 303. When the speed of the motor 202 is greater than or equal to the base speed of the motor 202, the first output 303 is zero because the integral gain k_{idd} is zero. Further, the d-axis voltage calculation module 300 can apply a gain 314 (e.g., via multiplication) to obtain a negated q-axis current error signal 316. As such, the gain 314 may have a value of negative one (−1). The d-axis voltage calculation module 300 may then apply the integral gain k_{idq} (e.g., via multiplication) to the negated q-axis current error signal 316 to obtain a second output 318. The d-axis voltage calculation module 300 may be further configured to combine the first output 303 to the second output 318 (e.g., via a summator 317) to obtain a third output 319. The d-axis voltage calculation module 300 may be further configured to integrate the third output 319 via an integrator 320 to obtain the second signal 306.

The second signal 306 may be constrained by an upper limit 322 and a lower limit 324. In some embodiments, the d-axis voltage calculation module 300 may be configured to determine the upper limit 322 and the lower limit 324. The upper limit 322 and the lower limit 324 may be determined based, at least in part, on the maximum phase voltage (Vₘₐₓ). For example, as shown, the maximum phase voltage (Vₘₐₓ) can be provided to a peak detector 326 configured to determine a peak 328 (i.e., maximum absolute value) of the maximum phase voltage (Vₘₐₓ). The peak 328 can then be compared (e.g., at a comparator 330) to the first signal 304 to determine the upper limit 322. Additionally, a gain 331 can be applied (e.g., via multiplication) to the peak 328 to obtain a negated peak 332. As such, the gain 331 may have a value of negative one (−1). The negated peak 332 can then be compared (e.g., at the comparator 330) to the first signal 304 to determine the lower limit 324. Using the peak 328 to determine the upper and lower limits 322, 324 can prevent clipping of the d-axis voltage component signal (v_{d}), which may be caused by wind up of the integrator 320 in response to ripple in the maximum phase voltage (Vₘₐₓ).

Referring now to FIG. 5B, the q-axis voltage calculation module 400 receives the q-axis and d-axis current error signals (e_{iq}), (e_{id}). The q-axis voltage calculation module 400 may be configured to determine the q-axis voltage component signal (v_{q}) based on the q-axis and d-axis current error signals (e_{iq}), (e_{id}). More specifically, the q-axis voltage calculation module 400 may be configured to determine the q-axis voltage component signal (v_{q}) by combining (e.g., via a summator 402) a third signal 404 and a fourth signal 406 to obtain an output 407.

The q-axis voltage calculation module 400 may be further configured to constrain the output 407 via a saturator 409 to obtain the q-axis voltage component signal (v_{g}). The q-axis voltage component signal (v_{g}) can be constrained by an upper limit 408 and a lower limit 410. In some embodiments, the q-axis voltage calculation module 400 may be configured to determine the upper limit 408 and the lower limit 410. The upper limit 408 and the lower limit 410 may be determined based, at least in part, on a second voltage threshold. The second voltage threshold may be referred to herein as a remaining phase voltage (Vᵣ). The remaining phase voltage (Vᵣ) may, for example, be a variable voltage dependent on the maximum phase voltage (Vₘₐₓ) and the d-axis voltage component signal (v_{d}). For example, the q-axis voltage calculation module 400 can be configured to determine the remaining phase voltage (Vᵣ) based on the following relationship:

$${V}_{r} = \sqrt{( {V}_{max}^{2} - {v}_{d}^{2} )}$$

As shown, the remaining phase voltage (Vᵣ) can be the upper limit 408. Additionally, a gain 411 can be applied (e.g., via multiplication) to the remaining phase voltage (Vᵣ) to obtain a negated remaining phase voltage 412. As such, the gain 411 may have a value of negative one (−1). The negated remaining phase voltage 412 can be the lower limit 410.

The q-axis voltage calculation module 400 may be configured to determine the third signal 404 based on the q-axis current error signal (e_{iq}). For example, the q-axis voltage calculation module 400 may be configured to apply the second proportional gain k_{pqq} (e.g., via multiplication) to the q-axis current error signal (e_{iq}) to obtain a second proportional signal 401. Additionally, the q-axis voltage calculation module 400 may be configured to apply the integral gain k_{iqq} (e.g., via multiplication) to the q-axis current error signal (e_{iq}) to obtain the third signal 404. The second proportional gain k_{pqq} may be a fixed gain (e.g., determined empirically based on testing and/or simulation to determine a value that maximizes control stability for the motor). The second proportional gain k_{pqq} may have a same value as the first proportional gain k_{pdd}.

Further, the q-axis voltage calculation module 400 may be configured to determine the fourth signal 406 based, at least in part, on the d-axis current error signal (e_{id}). When the speed of the motor 202 is less than the base speed of the motor, the second signal 306 may be determined based on the q-axis current error signal (e_{iq}) and the d-axis current error signal (e_{id}). For example, the q-axis voltage calculation module 400 may be configured to apply the integral gain k_{iqq} (e.g., via multiplication) to the q-axis current error signal (e_{iq}) to obtain a fourth output 403. When the speed of the motor 202 is greater than or equal to the base speed of the motor 202, the fourth output 414 is zero because the integral gain k_{iqq} is zero. Further, the q-axis voltage calculation module 400 can apply the integral gain k_{iqd} (e.g., via multiplication) to the d-axis current error signal (e_{id}) to obtain a fifth output 414. The q-axis voltage calculation module 400 may be further configured to combine the fourth output 303 to the fifth output 414 (e.g., via a summator 417) to obtain a sixth output 419. The q-axis voltage calculation module 400 may be further configured to integrate the sixth output 419 via an integrator 416 to obtain the fourth signal 406.

The fourth signal 406 may be constrained by an upper limit 418 and a lower limit 420. In some embodiments, the q-axis voltage calculation module 400 may be configured to determine the upper limit 418 and the lower limit 420. The upper limit 418 and the lower limit 420 may be determined based, at least in part, on the remaining phase voltage (Vᵣ). For example, as shown, the remaining phase voltage (Vᵣ) can be provided to a peak detector 422 configured to determine a peak 424 (i.e., maximum absolute value) of the remaining phase voltage (Vᵣ). The peak 424 can then be compared (e.g., at a comparator 426) to the third signal 404 to determine the upper limit 418. Additionally, a gain 427 can be applied (e.g., via multiplication) to the peak 424 to obtain a negated peak 428. As such, the gain 427 may have a value of negative one (−1). The negated peak 428 can then be compared (e.g., at the comparator 426) to the third signal 404 to determine the lower limit 420. Using the peak 428 to determine the upper and lower limits 418, 420 can prevent clipping of the q-axis voltage component signal (v_{q}), which may be caused by wind up of the integrator 416 in response to ripple in the maximum phase voltage (Vₘₐₓ).

The q-axis voltage component signal (v_{q}) can be configured to introduce a negative d-axis current (I_{d}) when the speed of the motor 202 is greater than or equal to the base speed. More specifically, because the q-axis voltage component signal (v_{q}) is limited by the remaining phase voltage (Vᵣ), the q-axis voltage component signal (v_{q}) will be unable to achieve the d-axis target current component signal

$$( {I}_{d}^{*} )$$

when the speed of the motor 202 is greater than or equal to the base speed. As such, a negative d-axis current (I_{d}) will result from the q-axis voltage component signal (v_{q}). The negative d-axis current (I_{d}) will be minimized and dynamically adjusted as a result of the remaining phase voltage (Vᵣ) limiting the q-axis voltage component signal (v_{q}) and being dependent on the d-axis voltage component signal (v_{d}).

The negative d-axis current (I_{d}) may implement a flux weakening operation that offsets the back-EMF of the motor 202. As such, the negative d-axis current (I_{d}) can reduce a total voltage required to operate the motor, while at the same time, increasing the speed of the motor 202 above the base speed. Minimizing and dynamically adjusting the negative d-axis current (I_{d}) increases the efficiency of the motor 202 by preventing excessive current from being applied to implement the flux weakening operation. Further, determining the q-axis voltage component signal (v_{q}) after the d-axis voltage component signal (v_{d}) prevents voltage ripple from propagating the torque by allowing the d-axis voltage component signal (v_{d}) to draw voltage from the maximum phase voltage (Vₘₐₓ) of the motor drive 204. As such, the voltage ripple is included in the remaining phase voltage (Vᵣ) and is thereby propagated to the flux weakening operation.

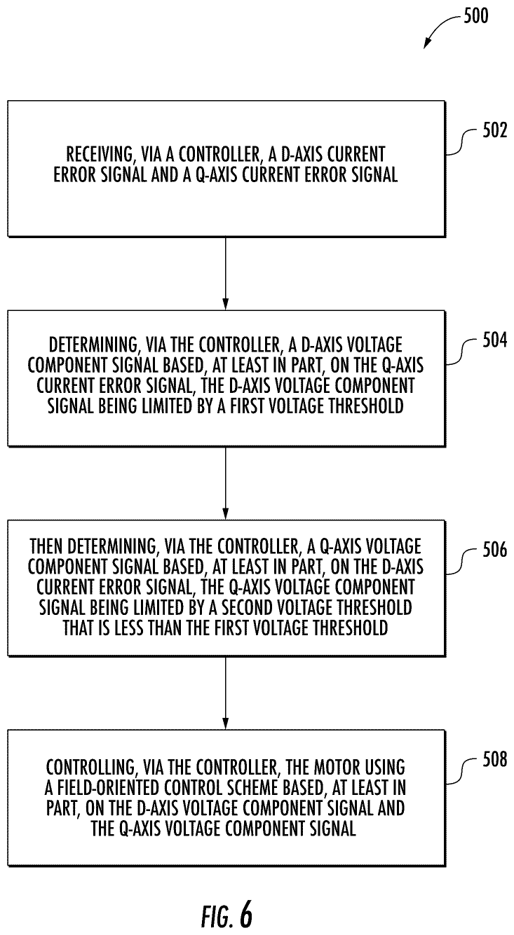

As mentioned above, embodiments of the present disclosure also include methods of controlling a motor for a domestic appliance, such as an example method 500 illustrated in FIG. 6. More particularly, the method 500 can be implemented in a field-oriented control (FOC) scheme (e.g., as depicted in FIG. 4). FIG. 6 provides steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, the method 500 is generally discussed with reference to the domestic appliance described above with reference to FIGS. 1-2, the motor 100 described above with reference to FIG. 3, and the motor assembly 200 described above with reference to FIG. 4. However, it should be understood that aspects of the present method 500 can find application with any suitable domestic appliance, motor assembly, motor, and/or controller.

The method 500 can include, at (502), receiving, via a current controller 218, a d-axis current error signal (e_{id}) and a q-axis current error signal (e_{iq}). For example, target current component signals

$$( {I}_{q}^{*} ) , ( {I}_{d}^{*} )$$

can be compared to measured current component signals (I_{q}), (I_{d}) to determine the d-axis current error signal (e_{id}) and the q-axis current error signal (e_{iq}), as discussed above.

The method 500 may also include, at (504), determining, via the current controller 218, a d-axis voltage component signal (Va) based, at least in part, on the q-axis current error signal (e_{iq}), as discussed above. For instance, the current controller 218 can be designed so as to decouple the voltage component signals (v_{q}), (v_{d}) from the current error signals (e_{iq}), (e_{id}), as discussed above. As such, the d-axis voltage component signal (v_{d}) can be determined sequentially before a q-axis voltage component signal (v_{q}), as discussed above. The d-axis voltage component signal (v_{d}) may be limited by a maximum phase voltage (Vₘₐₓ) of the motor drive, as discussed above. Hence, the d-axis voltage component signal (v_{d}) maximizes use of the DC bus voltage to achieve the q-axis target current component signal

$$( {I}_{q}^{*} ) .$$

The method 500 may also include, at (506), then determining, via the current controller 218, the q-axis voltage component signal (v_{q}) based, at least in part, on the d-axis current error signal (e_{id}), as discussed above. The q-axis voltage component signal (v_{q}) may further be limited by a remaining phase voltage (Vᵣ), as discussed above. More specifically, the q-axis voltage component signal (v_{q}) will be unable to achieve the target d-axis current component signal

$$( {I}_{d}^{*} )$$

when the motor 202 speed is greater than or equal to the base speed. As such, a negative d-axis current component signal (I_{d}) results from the q-axis voltage component signal (v_{q}) being limited by the remaining phase voltage (Vᵣ). Accordingly, a flux weakening operation is minimized by limiting the q-axis voltage component signal (v_{q}) by the remaining phase voltage (Vᵣ) and is dynamically adjusted in response to changes to the remaining phase voltage (Vᵣ).

The method 500 may also include, at (508), controlling, via the current controller 218, the motor 202 using the FOC scheme based, at least in part, on the d-axis voltage component signal (v_{d}) and the q-axis voltage component signal (v_{q}).

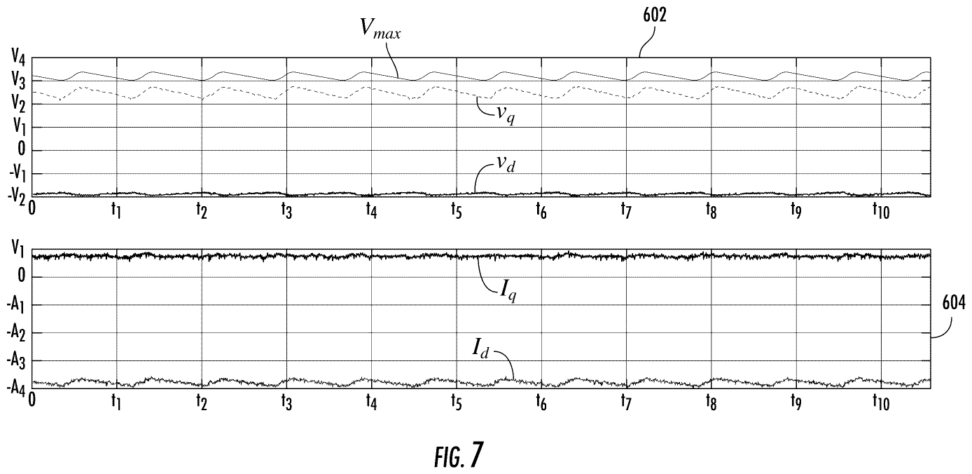

As an illustrative example, FIG. 7 provides correlated plots of testing results of the current controller 218 implementing the method 500 according to one or more exemplary embodiments of the present disclosure. Chart 602 depicts a d-axis voltage component signal (v_{d}), a q-axis voltage component signal (v_{q}), and a maximum phase voltage (Vₘₐₓ) represented in volts (y-axis) over a period of time (x-axis). Furthermore, chart 604 depicts measured current component signals (I_{q}), (I_{d}) represented in amperes (A) (y-axis) over the same period of time (x-axis) as that depicted in chart 602.

A controller (e.g., the current controller 218) can operate a motor (e.g., the motor 202) to achieve a dynamic flux weakening operation. More particularly, as shown in the charts 602, 604, prioritizing determination of the d-axis voltage component signal (v_{d}) minimizes and/or prevents ripple of the maximum phase voltage (Vₘₐₓ) from being included in the d-axis voltage component signal (v_{d}). As shown, the ripple of the maximum phase voltage (Vₘₐₓ) is included in the q-axis voltage component signal (v_{q}). As such, the ripple is not propagated in the q-axis current (I_{q}) and corresponding torque output by the motor 202. Instead, the d-axis current (I_{d}) includes the ripple, which permits the d-axis current (I_{d}) to dynamically adjust over time. Hence, the flux weakening operation is minimized, which improves the efficiency of the motor 202.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling a motor of a domestic appliance, the method comprising:
receiving, via a controller, a d-axis current error signal and a q-axis current error signal;
determining, via the controller, a d-axis voltage component signal based, at least in part, on the q-axis current error signal, the d-axis voltage component signal being limited by a first voltage threshold;
then determining, via the controller, a q-axis voltage component signal based, at least in part, on the d-axis current error signal, the q-axis voltage component signal being limited by a second voltage threshold that is less than the first voltage threshold; and
controlling, via the controller, the motor using a field-oriented control scheme based, at least in part, on the d-axis voltage component signal and the q-axis voltage component signal.

2. The method of claim 1, wherein the first voltage threshold is a maximum phase voltage of a motor drive, and the second voltage threshold is a variable voltage dependent on the d-axis voltage component signal and the first voltage threshold.

3. The method of claim 1, wherein the q-axis voltage component signal is configured to introduce a negative d-axis current when a speed of the motor is greater than a base speed of the motor.

4. The method of claim 1, wherein determining, via the controller, the d-axis voltage component signal based, at least in part, on the q-axis current error signal further comprises:
applying a first integral gain to the q-axis current error signal to obtain a first signal, the first integral gain being a variable gain dependent on a speed of the motor; and
determining the d-axis voltage component signal based, at least in part, on the first signal.

5. The method of claim 4, wherein the q-axis current error signal is limited by a peak of the first voltage threshold.

6. The method of claim 1, further comprising determining, via the controller, the d-axis voltage component signal based additionally on the d-axis current error signal.

7. The method of claim 6, wherein determining, via the controller, the d-axis voltage component signal based additionally on the d-axis current error signal further comprises:
applying a first proportional gain to the d-axis current error signal to obtain a first signal, the first proportional gain being a fixed gain;
determining a second signal based, at least in part, on the q-axis current error signal; and
determining the d-axis voltage component signal based on the first signal and the second signal.

8. The method of claim 7, further comprising:
applying a first integral gain to the q-axis current error signal to obtain a first output, the first integral gain being a variable gain dependent on a speed of the motor;
applying a second integral gain to the d-axis current error signal to determine a second output, the second integral gain configured to be zero when a speed of the motor is greater than or equal to a speed threshold; and
determining the second signal based on the first output and the second output.

9. The method of claim 1, wherein determining, via the controller, the q-axis voltage component signal based, at least in part, on the d-axis current error signal further comprises:
applying a third integral gain to the d-axis current error signal to obtain a third signal, the third integral gain being a variable gain dependent on a speed of the motor; and
determining the q-axis voltage component signal based, at least in part, on the third signal.

10. The method of claim 9, wherein the d-axis current error signal is limited by a peak of the second voltage threshold.

11. The method of claim 1, further comprising determining, via the controller, the q-axis voltage component signal based additionally on the q-axis current error signal.

12. The method of claim 11, wherein determining, via the controller, the q-axis voltage component signal based additionally on the q-axis current error signal further comprises:
applying a second proportional gain to the q-axis current error signal to obtain a third signal, the second proportional gain being a fixed gain;
determining a fourth signal based, at least in part, on the d-axis current error signal; and
determining the q-axis voltage component signal based on the third signal and the fourth signal.

13. The method of claim 12, further comprising:
applying a third integral gain to the d-axis current error signal to obtain a third output, the third integral gain being a variable gain dependent on a speed of the motor;
applying a fourth integral gain to the q-axis current error signal to determine a fourth output, the fourth integral gain configured to be zero when a speed of the motor is greater than or equal to a speed threshold; and
determining the fourth signal based on the third output and the fourth output.

14. The method of claim 1, wherein the motor is a permanent magnet synchronous motor.

15. A motor system comprising:
a motor having a rotor and a stator; and
a controller configured to control the motor, the controller configured to perform operations for controlling the motor, the operations comprising:
receiving a d-axis current error signal and a q-axis current error signal;
determining a d-axis voltage component signal based, at least in part, on the q-axis current error signal, the d-axis voltage component signal being limited by a first voltage threshold;
then determining a q-axis voltage component signal based, at least in part, on the d-axis current error signal, the q-axis voltage component signal being limited by a second voltage threshold that is less than the first voltage threshold; and
controlling the motor using a field-oriented control scheme based, at least in part, on the d-axis voltage component signal and the q-axis voltage component signal.

16. The motor system of claim 15, wherein the first voltage threshold is a maximum phase voltage of a motor drive, and the second voltage threshold is a variable voltage dependent on the d-axis voltage component signal and the first voltage threshold.

17. The motor system of claim 15, wherein the q-axis voltage component signal is configured to introduce a negative d-axis current when a speed of the motor is greater than a base speed of the motor.

18. A motorized appliance, comprising:
at least one motorized component; and
a motor system configured to drive the at least one motorized component; wherein the motor system comprises:
a motor having a rotor and a stator; and
a controller configured to control the motor, the controller configured to perform operations for controlling the motor, the operations comprising:
receiving a d-axis current error signal and a q-axis current error signal;
determining a d-axis voltage component signal based, at least in part, on the q-axis current error signal, the d-axis voltage component signal being limited by a first voltage threshold;
then determining a q-axis voltage component signal based, at least in part, on the d-axis current error signal, the q-axis voltage component signal being limited by a second voltage threshold that is less than the first voltage threshold; and
controlling the motor based, at least in part, on the d-axis voltage component signal and the q-axis voltage component signal using a field-oriented control scheme.

19. The motorized appliance of claim 18, wherein the first voltage threshold is a maximum phase voltage of a motor drive, and the second voltage threshold is a variable voltage dependent on the d-axis voltage component signal and the first voltage threshold.

20. The motorized appliance of claim 18, wherein the q-axis voltage component signal is configured to introduce a negative d-axis current when a speed of the motor is greater than a base speed of the motor.
